(19) United States
(12) Patent Application Publication
(10) Pub. No.: US 2012/0268227 A1
(43) Pub. Date: Oct. 25, 2012

(54) EMBEDDED COOLING OF WOUND ELECTRICAL COMPONENTS

(76) Inventors: Jeremy Howes, Charlotte, NC (US); Abhijit Sathe, Charlotte, NC (US)

(21) Appl. No.: 13/497,949

(22) PCT Filed: Sep. 24, 2010
(86) PCT No.: PCT/US10/50131

§ 371 Date: Jul. 12, 2012

Related U.S. Application Data
(60) Provisional application No. 61/245,320, filed on Sep. 24, 2009.

(51) Int. Cl. H01F 27/18

(52) U.S. Cl. 336/57

(57) ABSTRACT

A pumped liquid multiphase transformer cooling system utilizes a cold plate evaporator positioned between, insulated from, and in thermal contact with, the core and winding of the transformer. The system includes a condenser and a pump to move the multiphase refrigerant through the cold plate and the condenser and back to the pump.

### CROSS REFERENCE TO RELATED APPLICATIONS

The present application claims the benefit of the filing date of U.S. Provisional Patent Application Ser. No. 61/245,320, filed Sep. 24, 2009, the disclosure of which is incorporated herein by reference in its entirety.

### TECHNICAL FIELD

The present invention relates generally to electric components having a core and a winding surrounding the core (such as transformers), and more particularly to a pumped liquid multiphase cooling system for cooling electric components having a core and a winding surrounding the core.

### BACKGROUND OF THE INVENTION

Transformers are used to transfer electric power between circuits that operate at different voltages. A simple model of a transformer consists of two insulated electrical windings, a primary and a secondary, coupled by a common magnetic circuit. When an alternating voltage is applied to the primary winding, an alternating current will flow to a load connected to the secondary winding.

It is well known that the resistance of a given length of wire increases as its temperature increases. Drawing current through a wire causes a certain degree of heating, thus raising the resistance and lowering the voltage/current available to the load. In wound electrical components such as transformers, these heating losses (also referred to as IR² losses) can be minimized with proper cooling.

Transformers are usually quite large and generate great amounts of heat. Traditional methods of cooling transformers include fluid cooling or immersing the transformer in oil. Transformers cooled by oil immersion may be more efficient at cooling the transformer, however oil immersed transformers pose a risk to the environment through possible contamination resulting from spills during maintenance, repair or damage to the transformer oil tank.

### SUMMARY

At least one embodiment of the invention provides a cooling system for an electric component having a core and a winding surrounding the core, the system comprising: a cold plate/evaporator positioned adjacent an exterior surface of the core and at least partially surrounded by the winding such that the cold plate is between the core and the winding and electrically insulated from the core and the winding; a fluid circuit attached to the cold plate/evaporator; and a refrigerant flowing through the fluid circuit, the refrigerant entering the cold plate evaporator as a liquid and exiting the cold plate evaporator as a combination of liquid and gas.

At least one embodiment of the invention provides transformer cooling system comprising: a transformer having a core and a winding surrounding the core, the transformer generating heat; a cold plate evaporator in thermal contact with the core and the winding of the transformer, the cold plate evaporator electrically insulated from the core and the winding; a fluid circulated by a pump through a fluid conduit to the cold plate evaporator, whereby the fluid is at least partially evaporated by the heat generated by the transformer, creating a vapor, through a condenser for condensing the vapor, creating a single liquid phase, and back to the pump.

### BRIEF DESCRIPTION OF THE DRAWINGS

Embodiments of this invention will now be described in further detail with reference to the accompanying drawing, in which:

FIG. 1 is a schematic view of the cooling system shown without the electrical components to be cooled;

FIG. 2 is a perspective view of a portion of the cooling system having a plurality of cold plate/evaporators fluidly connected to each other and shown without the electrical components to be cooled;

FIG. 3 is a perspective view of the cooling system of FIG. 2 shown with cold plate/evaporators positioned adjacent the cores of an electrical component such as a transformer; and

FIG. 4 is a perspective view of a cooling system of FIG. 2 shown embedded between the cores shown in FIG. 3 and the windings surrounding the cores.

### DETAILED DESCRIPTION OF THE DRAWINGS

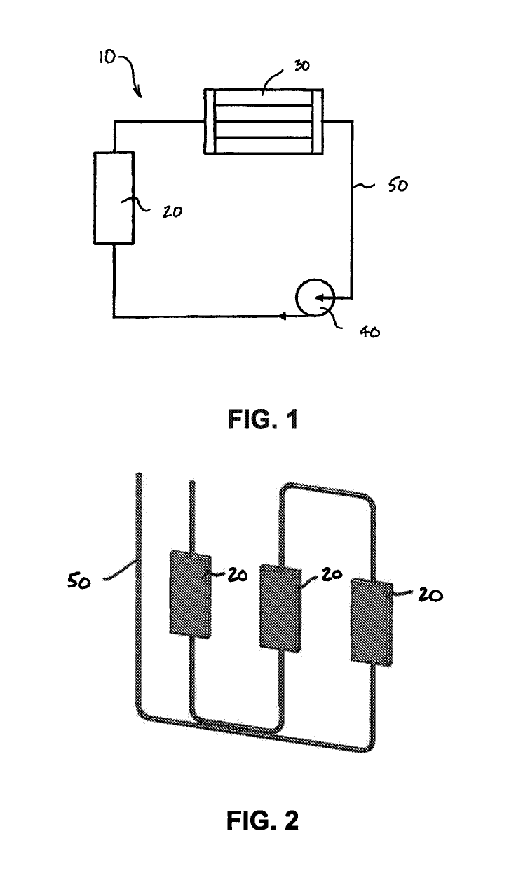

A pumped liquid multiphase cooling system 10 is shown in FIG. 1 and comprises a cold plate/evaporator 20, a condenser 30 and a pump 40, connected to each other by fluid conduits 50. A fluid such as a two phase R134A refrigerant is pumped through the system 10 to cool a component attached to the cold plate/evaporator 20. In the cold plate/evaporator 20, the heat generated by the electronic component is transferred to the fluid, causing the fluid to partially vaporize. The fluid then travels to the condenser 20 wherein the heat is rejected from the system 10 and the fluid returns to the cold plate/evaporator 20 by way of the pump 40.

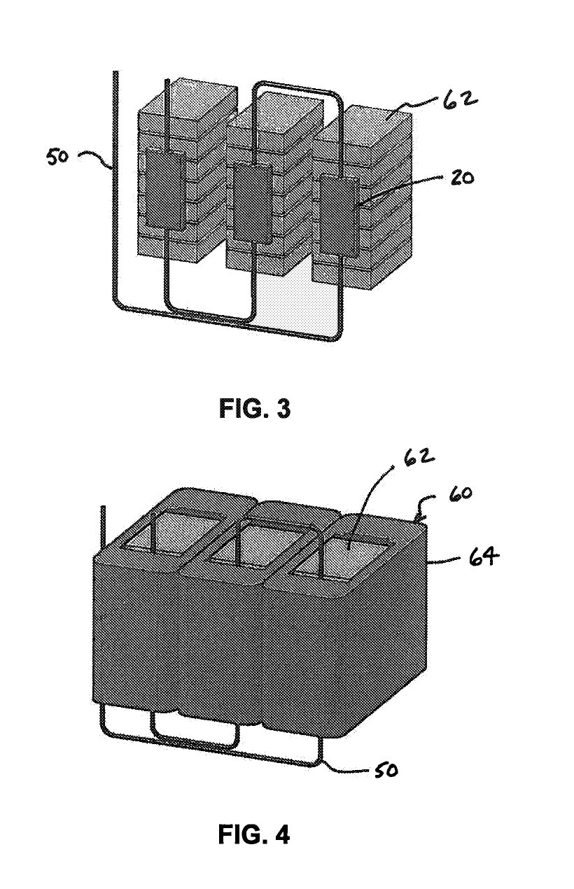

Referring to FIG. 2, the cooling system 10 may comprise more than one cold plate/evaporator 20 in the fluid circuit formed by conduits 50. As shown in FIG. 3, the cold plate/evaporators 20 are positioned adjacent the cores 62 of a wound electrical component 60, (such as a transformer). The windings 64 of the electrical component 60 are shown in FIG. 4 such that the cold plate/evaporators 20 is positioned adjacent an exterior surface of the core 62 and at least partially surrounded by the winding 64 such that the cold plate 20 is between the core 62 and the winding 64. An electrically insulating material (not shown) is used between the core and the cold plates and the windings and cold plates to prevent electric short-circuit.

In operation, the pump forces liquid refrigerant through the conduits 50 of the circuit to the cold plate/evaporators 20 between the core 62 and the winding 64 of the electric component 60. Heat from the electric component 60 is transferred to the refrigerant in the cold plate 20. When sufficient heat is transferred, the refrigerant reaches its boiling point and at least partially evaporates. The refrigerant may then travel to additional cold plate evaporators 20 if positioned in a circuit in series where additional heat is transferred to the refrigerant. Once the partially evaporated (two phase) refrigerant leaves the evaporators 20, the refrigerant travels through the conduit 50 to the condenser where the heat is removed to the refrigerant such that the refrigerant returns to liquid form and is returned to the pump.

It is contemplated that each core/winding can include multiple cold plates with each cold plate/evaporator positioned adjacent an exterior surface of the core and at least partially surrounded by the winding such that the cold plate is between the core and the winding.

Although the principles, embodiments and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention. Accordingly, the scope and content of the present invention are to be defined only by the terms of the appended claims.

What is claimed is:

1. A cooling system for an electric component having a core and a winding surrounding the core, the system comprising:
a cold plate/evaporator positioned adjacent an exterior surface of the core and at least partially surrounded by the winding such that the cold plate is between the core and the winding and is electrically insulated from the core and the winding;
a fluid circuit attached to the cold plate/evaporator; and
a refrigerant flowing through the fluid circuit, the refrigerant entering the cold plate evaporator as a liquid and exiting the cold plate evaporator as a combination of liquid and gas.

2. The system of claim 1, further comprising a plurality of cold plate/evaporators, each positioned adjacent an exterior surface of the core and at least partially surrounded by the winding such that the cold plate is between the core and the winding.

3. The system of claim 1, the fluid circuit attached to the cold plate/evaporator further comprising a pump.

4. The system of claim 1, the fluid circuit attached to the cold plate/evaporator further comprising a condenser.

5. The system of claim 2, the plurality of cold plate/evaporators positioned in the fluid circuit in series.

6. The system of claim 2, the plurality of cold plate/evaporators positioned in the fluid circuit in parallel.

7. A transformer cooling system comprising:
a transformer having a core and a winding surrounding the core, the transformer generating heat;
a cold plate evaporator in thermal contact with the core and the winding of the transformer, the cold plate evaporator electrically insulated from the core and the winding;
a fluid circulated by a pump through a fluid conduit to the cold plate evaporator, whereby the fluid is at least partially evaporated by the heat generated by the transformer, creating a vapor, through a condenser for condensing the vapor, creating a single liquid phase, and back to the pump.

8. The system of claim 7, further comprising a plurality of cold plate/evaporators, each positioned within one of a plurality of transformers.

9. The system of claim 8, the plurality of cold plate/evaporators positioned in the fluid circuit in series.

10. The system of claim 8, the plurality of cold plate/evaporators positioned in the fluid circuit in parallel.
